(19) United States
(12) Patent Application Publication
(10) Pub. No.: US 2025/0254087 A1
(43) Pub. Date: Aug. 7, 2025

(54) SYSTEM AND METHOD FOR CONFIGURING A NETWORK INTERFACE DEVICE

(71) Applicant: Trango Networks, LLC, Random Lake, WI (US)

(72) Inventors: Christopher A. GUSTAF, San Diego, CA (US); James BERTRAM, Adell, WI (US)

(21) Appl. No.: 19/046,359

(22) Filed: Feb. 5, 2025

Related U.S. Application Data
(60) Provisional application No. 63/549,839, filed on Feb. 5, 2024.

(51) Int. Cl. H04L 41/0806; H04L 41/084; H04L 67/1097

(52) U.S. Cl. CPC H04L 41/0806; H04L 41/084; H04L 67/1097

(57) ABSTRACT

A system method for provisioning a network interface device comprising providing a network interface device having a controller for controlling the network device and a plurality of ports, wherein one or more of the plurality of ports are associated with a user, wherein the controller includes memory for storing an initial configuration file associated with the network device, storing the initial configuration file and generating from the initial configuration file a final configuration file based on network interface device related information, including Quality of Service information and device identification information, processing the initial configuration by the network interface device when a boot sequence is initiated, receiving address information associated with the network interface device, locating and downloading by the network interface device the final configuration file, and automatically rebooting the network interface device to process the final configuration file.

### RELATED APPLICATION

The present application claims priority to U.S. provisional patent application Ser. No. 63/549,839, filed on Feb. 5, 2024, entitled Active Network Interface Device With Autoconfiguration, the contents of which are herein incorporated by reference.

### BACKGROUND OF THE INVENTION

High-speed Internet access is essential for modern communications, supporting applications ranging from residential broadband to enterprise networking. Fiber optic networks provide a reliable and high-bandwidth solution for delivering Internet services to multiple network users. To reduce infrastructure costs, service providers commonly deploy Passive Optical Networking (PON) technology, which utilizes optical splitters to share a single fiber optic link among multiple end users.

A typical PON system employs Time Division Multiple Access (TDMA) for upstream data transmission, allowing multiple users to share a common fiber link by allocating different time slots to each user. This approach eliminates the need for dedicated fiber runs to each end-user premise, significantly reducing the cost of fiber deployment and maintenance.

Conventional PON systems, however, suffer from several limitations. Due to the passive nature of optical splitters, upstream bandwidth is constrained, limiting each user to a fraction of the total available upstream bandwidth. This restriction can degrade performance, particularly in scenarios where multiple users require simultaneous high-speed upstream data transmission. Furthermore, the fiber segment extending from the optical splitter to the Network Interface Device (NID) at the customer premises operates at the same speed as the backhaul portion from the splitter to the Network Operations Center (NOC). This requirement imposes additional constraints on network flexibility and efficiency, preventing the network from dynamically allocating bandwidth based on user demand.

As Internet usage continues to grow, these limitations in conventional PON architectures create bottlenecks that hinder the delivery of high-speed, symmetrical broadband services. Accordingly, there is a need for an improved system and method that overcomes these drawbacks and enhances the efficiency of fiber optic network deployments.

### SUMMARY OF THE INVENTION

The present invention is directed to a network interface device (NID) that is deployed by an internet service provider (ISP) that can be installed at a customer or user premises. The network interface device forms part of a network interface system that employs one or more servers from one or more of the device manufacturer and the ISP for generating and downloading an initial configuration file, and for generating a final configuration file from the initial configuration file. The initial configuration file includes device settings and optionally network settings. The final configuration file can be downloaded to the network interface device and can be processed by an on-board controller when the device is turned on and boots up. During the boot up sequence, the network interface device executes the operating system software, searches for the initial configuration file, and then processes the configuration file. When the initial configuration file is processed, the device applies the settings stored therein. The device then processes network settings to establish the required and proper network connections. The network interface device then searches for and downloads the final configuration file and then compares the final configuration file with the configuration file stored therein. If the files match, then the new configuration file is discarded. If the files do not match, then the new configuration file is used and stored in memory.

The network interface device can include power converter modules to convert input power to power levels suitable for use by the various device components. The device can also include a controller that has a plurality of ports associated therewith. The ports can be assigned to specific end users. The device also includes a GPS module to provide GPS data to the controller to optionally establish a geo-fence around the network interface device. An input electrical component, such as a diode, can be employed to pass along to the power converter module the input power or power from a second device source, such as a power over ethernet (PoE) source.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of a network interface system employing a network interface device according to the teachings of the present invention.

FIG. 2 is a schematic block diagram of a network interface device employed by the network interface system according to the teachings of the present invention.

FIG. 3 is a schematic flow chart illustrating the method of installing and provisioning the network interface device according to the teachings of the present invention.

### DETAILED DESCRIPTION OF THE INVENTION

The present invention is directed to a network interface device suitable for use with Ethernet and having multiple user ports and at least one wide area network (WAN) port that can be used to provide Internet access to a residential or commercial location. The network interface device can automatically load a final configuration file to provision the user ports in the network interface device 30, which can be individually assigned to separate end users. By using a relay server, such as a Dynamic Host Configuration Protocol (DHCP) server, only authorized devices can be provisioned and assigned to the network, thereby increasing network security. The DHCP server is essentially a network service that automatically assigns internet protocol (IP) addresses and other network configuration settings to the network interface devices on the network. The network interface device can automatically provide performance metrics and system information including the location of the network interface device to ensure compliance with applicable regulations.

The present invention can employ active optical networking (AON) full duplex connections for all network interface devices and can replace the splitter with a managed switch or router. As more network interface devices are added to the network interface system, the backhaul capacity of the system can be increased by using higher data rate connections on the backhaul fiber segments, thus increasing the real capacity available for each network interface device.

To simplify the installation and provisioning of the network interface devices on the network, the present invention can employ a multi-step (e.g., two-step) automated configuration process. For example, upon boot up, the network interface device can either download, or has stored thereon, an initial configuration file from a server that has the server credentials to access a storage server and save the initial configuration file to local memory. The network interface device can then reboot and then automatically download and run a final configuration file based on quality of service (QOS) settings that can be stored or contained within the initial configuration file. The quality of service (QOS) settings are configuration settings that control the prioritization, bandwidth allocation (e.g., data rate and/or data capacity), and the overall performance of data transmission across a network. The settings help ensure that selected data receive the necessary resources while minimizing latency and packet loss. At an ISP router, a custom network management system (NMS) can be used to create or transfer the initial configuration files and push them to a file server when the network interface device is installed at the customer premises.

The final configuration file can include, for example and according to one embodiment, the information needed to individually provision one or more of the active ports on the network interface device. The user router coupled to the NID can receive a specific IP address from the NMS of the ISP router by utilizing a relay server (e.g., DHCP relay server) having remote identification (ID) information that uniquely identifies the network interface device, port and local area network (e.g., LAN or VLAN) used by the router. In one embodiment of the present invention, the remote ID field can include a unique media access control (MAC) address of the network interface device. The MAC address is a unique identifier assigned to the network interface device. The MAC address can include a 48-bit (or sometimes 64-bit) address, typically represented in hexadecimal format (e.g., 00:1A:2B:3C:4D:5E). The MAC address is used for communication within a local area network (LAN) and helps the network interface devices identify each other at the data link layer. Each MAC address is globally unique and is assigned by the device manufacturer, and includes information associated with the device manufacturer and the network interface device.

To ensure performance compliance with government reporting requirements, a custom report can be generated and sent to the internet service provider on a periodic basis which contains uptime, capacity availability and usage metrics over a specified period of time. The report can also include real test data to show that the capacity sold to the end-user is verifiable. For security measures, the network interface device can include structure for receiving global positioning satellite (GPS) data that provides mapping and timing information. The network interface device can be geo-fenced so that the device cannot be removed and used in a different location.

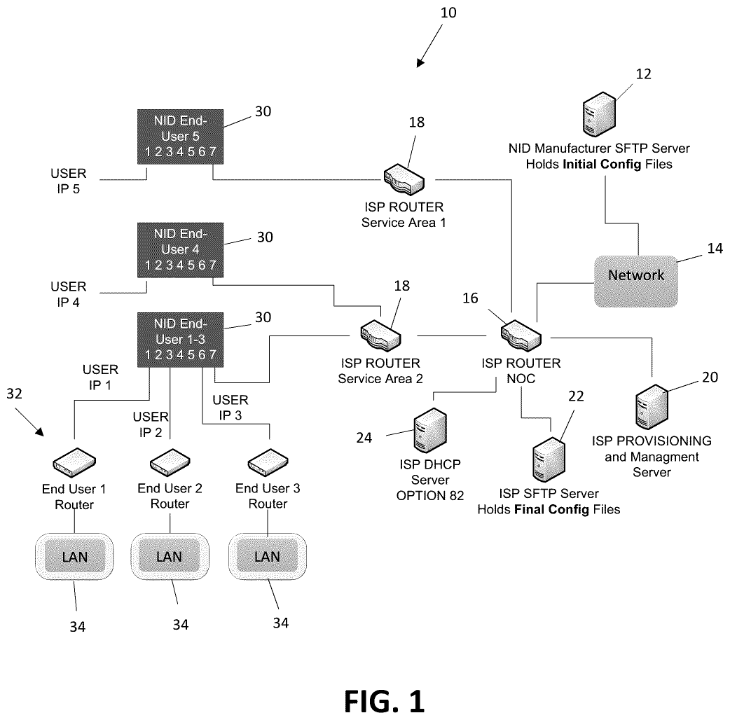

FIG. 1 is a schematic block diagram of a network interface system and associated network according to the teachings of the present invention. The illustrated network interface system 10 includes a server 12 that is associated with the manufacturer of a network interface device (NID) that is configured for storing information associated with the network interface device. According to one embodiment, the server 12 can be used by the NID manufacturer to store and distribute initial configuration files and other types of data for newly manufactured, sold, deployed or installed network interface devices or for preexisting network interface devices. Specifically, the server 12 helps provisioning and deployment of the network interface devices by storing initial configuration files that can be downloaded by the network interface device upon first boot, reboot, or during remote provisioning. Alternatively, a copy of the initial configuration file can be prestored within the network interface device. The initial configuration file, in the context of a network interface device, refers to a structured data file that defines initial operational parameters, settings, and preferences for the network interface device. The configuration file can include one or more of network protocols, security settings, hardware resource allocations, communication parameters, and other device-specific configurations. The configuration file can thus serve or function as an initial setup template that defines how the network interface device functions within the system 10. According to one embodiment, the initial configuration file does not include quality of service settings, port related information, data rate or capacity information, relay server information, port priority information, and the like. The initial configuration file ensures that the network interface device connects to the correct network infrastructure and registers with the service provider's monitoring and management system. The initial configuration file can include one or more of, or any combination of, network settings (e.g., IP address (static or DHCP settings)), subnet mask and gateway information, DNS server addresses, authentication and security information, and the like, device credentials (e.g., username, password, SSH keys, and the like), secure communication settings (e.g., TLS/SSL encryption and the like), firewall rules and access control policies, network configurations and associated information (e.g., LAN or VLAN settings), remote management and monitoring information, event log information, firmware and software settings and associated information, configuration scripts for service provider customization, PON and fiber network parameters (if applicable), optical transceiver settings, ONU/OLT registration details, and the like. The initial configuration file allows the network interface device to quickly integrate into the network and establish communication with the service provider's operations center or the appropriate servers on the network, so as to connect with and download the final configuration file. The initial configuration file also enables automated provisioning, facilitates remote management, and ensures consistent operation by allowing the network interface device to retrieve and apply predefined configurations upon boot up, initialization, or during runtime. The initial configuration file can be formatted in various data encoding schemes, such as for example extensible markup language (XML), JavaScript object notation (JSON), or other types of binary formats. The server 12 can employ any selected type of file transfer or network communication protocol, such as for example a secure file transfer protocol (SFTP), to ensure that the initial and final configuration files are transferred safely and prevents unauthorized access or tampering by a third party. The internet service providers that can be coupled to the network interface system 10 can automate the configuration process by provisioning newly installed network interface devices to retrieve settings from the server 12, thereby reducing manual setup efforts. The server 12 can also host firmware updates and revised configurations, allowing the service providers to maintain consistency across deployed network interface devices.

The network interface system 10 also includes a network 14 that enables the server 12 to communicate with other system components and devices. The network 14 can be any suitable network, such as a wide area network (WAN) (e.g., the Internet), a local area network (LAN or VLAN), a metropolitan area network (MAN), and the like. The network 14 can also communicate with one or more switches or routers for routing data to selected portions of the system 10. According to one embodiment, the network interface system 10 can include a first router 16 of an internet service provider (ISP). The ISP router helps users connect to the network 14 using different types of connections, including fiber optics, cable, digital subscriber line (DSL), dial-up connections, satellite, wireless services, and the like. The router 16 is a networking device that forwards data, in the form of data packets, between computer networks and devices, and helps direct data traffic over the network 14 between the user and the broader Internet or network. The router 16 can also serve as a gateway for the user devices to access the Internet and communicate with each other over the network 14. The router 16 can be optionally configured as a network operations center (NOC) router that monitors and manages the routers used by the internet service provider. The NOC router can function as a central hub where the ISP's network infrastructure is observed, controlled, and maintained to ensure smooth, reliable internet service for customers. The NOC router 16 can be responsible for continuously monitoring the status and performance of all routers in the ISP's network, including those at the core, edge, and user/customer premises (e.g., routers 32). This includes checking uptime, traffic load, and error rates on the routers. The NOC router 16 can also be configured to transfer the initial configuration file from the server 12 over the network 14. The ISP can also deploy additional routers, indicated by the routers 18, for covering specific zones or geographical areas or regions. The routers 18 can communicate with the NOC router 16 and can be managed thereby. The routers 18 can also function to route and manage the data traffic in the specific or designated areas.

The network 14 can also communicate with one or more additional servers, including for example one or more ISP servers, such as a provisioning server 20, a storage server 22, and a relay server 24. The provisioning server 20 is a server used by the ISP to automate and manage the process of provisioning services and data to users or customers, including setting up new accounts, configuring network devices, and activating internet access. In the context of an ISP or ISP servers, provisioning refers to the process of preparing and configuring the necessary infrastructure and services to enable a customer or user to use the ISP's internet service. This involves tasks such as assigning an IP address, configuring customer equipment (e.g., routers or modems and network interface devices) based on user or installer information, enabling access to specific services, and ensuring the proper resources are available to meet the customer's needs. Provisioning can occur during service activation and can also involve ongoing updates or changes to a customer's service plan.

The provisioning server 20 can automate the configuration of the customer's service, including setting up the correct settings and parameters, including IP addresses, connection speed, Quality of Service (QOS) data, and network configurations. For example, when a user signs up for internet service, the provisioning server 20 can be configured to assign the user a specific IP address and ensures that their router or modem is configured correctly to access the ISP's network. The provisioning server 20 can also communicate with the customer's modem, router, or other network devices (NIDs), automatically configuring them with the correct settings, such as username/password combinations for authentication, network settings (e.g., DNS, DHCP), and any required firmware updates. The provisioning server 20 can create the customer's account and activate the account by linking the customer's information to their respective service plan (e.g., speed tier, usage limits, IP address allocation, and the like). If there are issues with a customer's service (e.g., connectivity problems), the provisioning server 20 can help identify misconfigurations or service discrepancies and can trigger automatic corrections or alerts for manual intervention. According to the present invention, the provisioning server 20 can also receive the initial configuration file from the server 12, via the network 14 and the router 16, and then generate therefrom a final configuration file based on the user provided data, including user identification information, bandwidth related information, and the like. The final configuration an be optionally conveyed to and stored in the storage server 22. The final configuration file can be retrieved by the network interface device 30 upon boot up or upon reboot.

The storage server 22 can be used to store, manage, and provide the final configuration files to other devices in the network or system and provide access to the network interface device final configuration files via any suitable network communication protocol, such as for example by way of a Secure File Transfer Protocol (SFTP). The Secure File Transfer Protocol (SFTP) is a network protocol that provides secure file transfer over a secure shell (SSH) connection. The protocol can be used to transfer files safely and efficiently between devices over a network, ensuring that the data is encrypted during both the transfer process and while at rest on the server. The final configuration files help facilitate setting up and maintaining the network interface devices that enable internet connectivity for the users. The storage server 22 can also function as a central repository for the final configuration files, allowing installers, network engineers and administrators, to easily retrieve, update, or backup the final configuration files. This simplifies network management and file version control. As such, the storage server 22 can store different versions of the final configuration files, allowing the ISPs to roll back to previous file versions if needed. Further, through user authentication and permissions, the storage server 22 can control access to the final configuration files, reducing the risk of unauthorized changes that can disrupt service. The storage server 22 can also be integrated with provisioning systems, such as the provisioning server 20, for automatically deploying the final configuration files to customer network interface devices, reducing manual intervention, and speeding up service activation.

The relay server 24 helps relay information to the network interfaces devices in the network interface system 10. For example, the relay server 24 can help enhance the security and management of IP address allocation, particularly in large networks. The relay server 24 can employ any suitable protocol, such as the dynamic host configuration protocol, to provide additional information about the location of a user requesting an IP address, enabling the server to make more informed decisions about IP address assignment. The DHCP protocol, which includes option 82, adds information about the physical or logical location of the DHCP client (e.g., user), such as information directed to which specific port on a switch or network device, or which subnet, the request originated from. This can include data such as a circuit identification (ID), which can refer to a specific customer or area, or a remote identification (ID), which can refer to a particular network device or port. By including information about where the DHCP request is originating, the option 82 helps prevent unauthorized DHCP clients from gaining IP addresses on the network. Without this option, malicious devices can impersonate legitimate clients and request IP addresses. The illustrated routers 18 can communicate with the network interface devices 30 of the present invention. The network interface devices 30 can be associated with specific users with specific IP addresses assigned by the provisioning server 20. The user can optionally employ a local router 32 at the user site or location, which can communicate with a local area network (LAN) 34. According to one embodiment, each port of the network interface device 30 can be assigned or associated with a specific user.

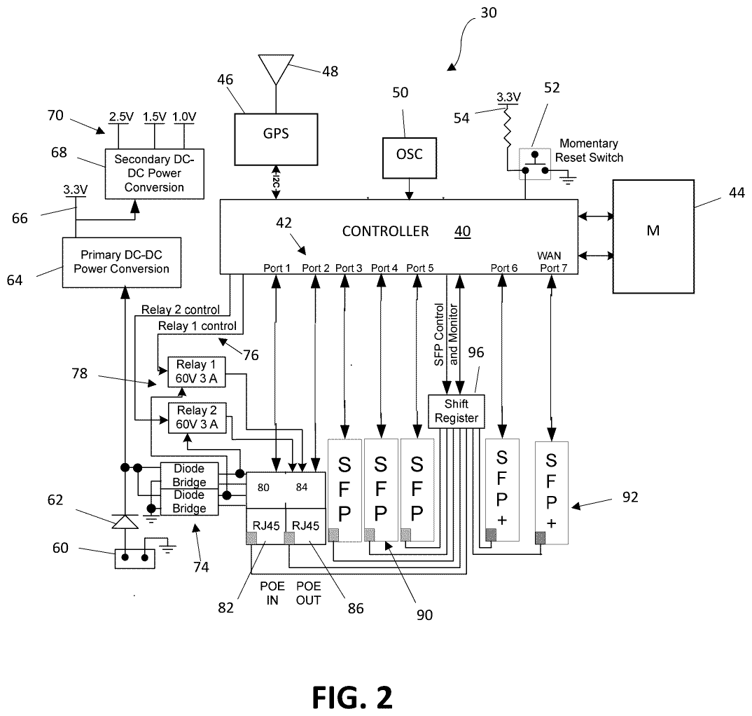

The details of the network interface device 30 of the present invention are shown for example in FIG. 2. According to one embodiment, the illustrated network interface device 30 can include a network section having a controller 40 for controlling and managing the network interface device and for providing a graphical user interface for system monitoring. The controller 40 can have a series of ports 42, such as for example ports 1-7, associated therewith. Those of ordinary skill in the art will readily recognize that the controller 40 can have any selected number of ports 42 and can utilize at any time all or less than all of the ports. The ports 42 can be associated with or assigned to specific users, and optionally can have a port dedicated to the wide area network (WAN) forming part of the network interface system 10. The ports 42 can communicate over different types of communication pathways, including ethernet type connections (e.g., RJ45 cable type connections employing twisted-pair copper wire), fiber optic type connectors, and the like. The fiber optic connectors can be optionally coupled to small form-factor pluggable (SFP) transceivers 90 and enhanced small form-factor pluggable (SFP+) transceivers 92 suitable for use in fiber optic and ethernet networking to enable high-speed data transmission. The transceivers 90, 92 can connect network devices, such as switches, routers, servers and network interface devices, to fiber optic or copper cables and to the controller 40. The SFP type transceivers can typically handle up to 1 Gbps data and the SFP+ type transceivers can typically handle up to 10 Gbps data. The controller 40 can include or can communicate with one or more memory or storage elements 44 for exchanging or receiving data therewith. For example, the illustrated network interface device 30 can include a memory element 44 for storing any suitable software to be processed by the controller. The software can include operating system software as well as the final configuration file received from the storage server 22. The final configuration file can refer to the fully processed and validated initial configuration file that defines the operational settings, parameters, and policies applied to the device before deployment or during runtime.

The network section can also include a GPS module 46 for communicating with a global positioning satellite system for receiving, via the antenna 48, GPS data indicative of the location of the network interface device. The network section also includes an oscillator module 50 that functions as a timing source for the network interface device that provides a stable clock signal for the controller 40 and other components. A reset module 52 can be provided to allow the installer or user to default the network interface device to the factory setting and automatically reboot the controller. The reset module 52 can be coupled to a device power source 54. The device power source 54 provides power at selected levels, such as at about 3.3V.

The illustrated network interface device 30 can also include a power conversion portion that helps convert input power to a level appropriate and suitable for use by the various device components. The network interface device 30 receives direct input power 60 that passes through a selected electrical component, such as a diode 62. The diode 62 can function as a logical OR component by passing either the input power 60 or some other power along to the power converters. The input power 60 can be passed to a first power converter module 64 to convert the input power 60 to a selected power level different than the input power level. According to one embodiment, the first power converter module 64 is a DC-DC power converter. The power converter 64 can convert the input power to a first device specific power level 66, such as for example 3.3V, that is suitable and useable by selected components of the device. The power level 66 outputted by the power converter 64 can be conveyed to a second power converter module 68 for converting the first power level 66 to a second power level 70 that is lower than the first power level 66. The second power level 70 can be one or more power levels, such as, for example, 2.5V, 1.5V and 1.0V. The second power converter module 68 can also be a DC-DC power converter. The second power levels can correspond to power levels appropriate for selected components of the network interface device 30. Those of ordinary skill will readily recognize that the power converters can convert the input power 60 to any selected power levels.

The network interface device 30 can also include a power over ethernet (POE) portion that includes one or more bridge rectifier circuits 74 for rectifying the input power 60. The bridge rectifier circuits can be configured as diode bridges for rectifying the input power 60. The network interface device 30 can also include one or more relay modules 78 that can be controlled by the controller 40 via control signals 76 to provide PoE out power to a second device that can be coupled to the device 30. The bridge circuits 74 and the relays 78 can also function to provide input power (e.g., PoE input) for the illustrated device. More specifically, the first port (Port 1) of the controller ports 42 can be optionally coupled to a first transformer 80 for transforming the power from the bridge circuits 74 to a power level that can be employed over an ethernet communication pathway, such as for example an RJ45 ethernet coupler 82. Similarly, the second port (e.g., Port 2) can be optionally coupled to a second transformer 84 for transforming the input power 60 from the bridge circuits to a power level that can be employed over an ethernet communication pathway, such as for example an RJ45 ethernet coupler 86. The Ports 3-5 can be optionally coupled to selected SFP transceivers 90 that allow the ports 42 to be coupled to selected fiber optic cable. Similarly, Ports 6-7 can be optionally coupled to enhanced SFP transceivers 92 for also allowing the ports to be coupled to fiber optic cable. The network interface device can also employ a shift register 96 for converting the data from the SFP modules 90, 92 and for other components into a format suitable for processing by the controller 40 and vice versa. The shift register 96 can also help buffer and synchronize the data. The PoE Out can be wired the same as the PoE Input to provide flexibility for various PoE wiring. The bridge rectifiers 74 from the PoE Input can supply the input voltage to the power converter module 64 regardless of the PoE wiring polarity. The second power converter module 68 provides lower voltages for the controller 40 and networking sections of the device. Further, the power input to the first power converter module 64 can be directly from the input power 60 or can be direct from the PoE Input on Port 1, whichever is higher in voltage. The output power (e.g., output voltage) from the first power converter module 64 can be connected directly to the internal power planes of the network interface device 30 and can supply power to the secondary power converter module 68 to generate power required by other components of the device. The first power converter module 64 can handle a wide range of power input levels (e.g., between about 9V and about 57V DC) and the PoE Input voltage can operate in a similar range. The bridge rectifiers 74 and the main diode 62 can function essentially as a logic OR gate and can direct or pass along either the input power 60 or the PoE Input voltage, whichever is higher, to the first power converter module 64. The PoE Input can operate from between four or eight wire standard PoE standards, and the PoE Input can be optionally routed to the relays 78 to allow powering of Port 2 via the same Port 1 wiring. By energizing either one (four wire standard) or both (eight wire standard) relays 78, a PoE device connected to Port 2 can be powered and rebooted.

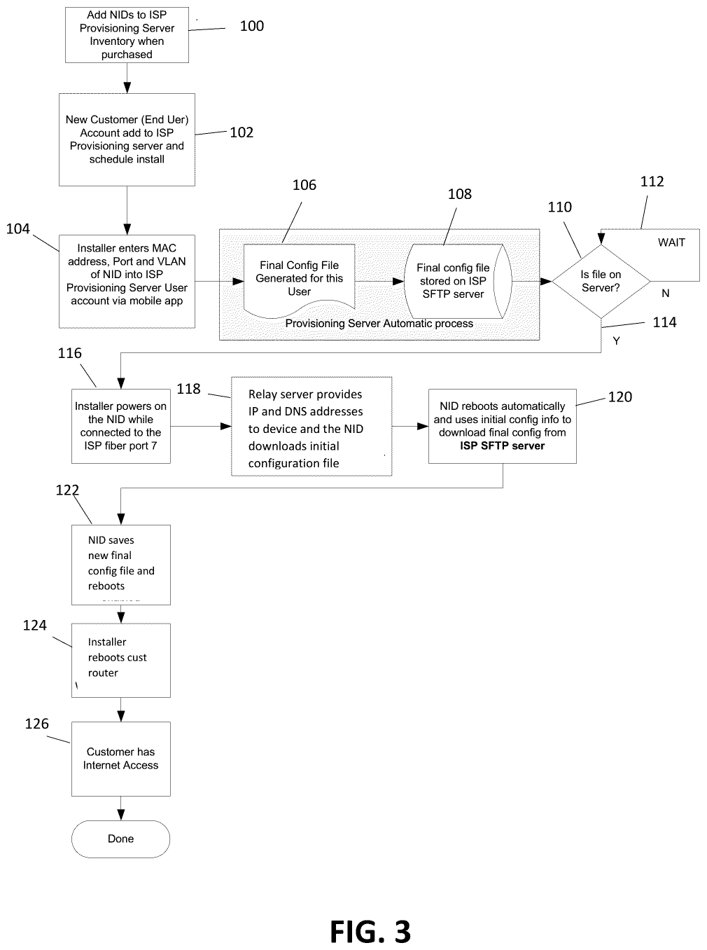

FIG. 3 is a schematic flow chart diagram showing the provisioning of the initial configuration file during installation and boot-up of the network interface device 30. When the internet service provider purchases the network interface device 30, the initial configuration file is uploaded by the manufacturer to the NID or manufacturer server 12 and is stored therein. The initial configuration file can also be stored in the network device. The initial configuration file is then conveyed from the NID server 12 to the provisioning server 20. Information associated with or related to the network interface device 30 can also be added to the provisioning server 20 when purchased by the ISP or user, step 100. Additionally, user information, such as user identification information (e.g., name, address, billing information, and the like) and assigned IP address, can also be stored in the provisioning server 20, and the installation of the network interface device 30 at the user can be scheduled, step 102. The installer of the network interface device 30 at the user (deemed “user” as used herein) can then enter selected network device specific or related information into the provisioning server 20, such as for example, QoS information, including any combination of device identification information, port related information, network related information, and the like, step 104. The device identification information can include, by simple way of example, a media access control (MAC) address, which is a unique identifier and hardware address that can be assigned to the network interface device 30 for communication over the network. The user information an also be added. The initial configuration file is then processed by the provisioning server 20 and converted into the final configuration and associated with the end user or customer, step 106. The final configuration file includes the initial configuration file as well as the device identification information (e.g., MAC address) and QoS information (e.g., bandwidth information, port information, priority information, and the like), and optionally the user information. The final configuration file is then conveyed from the provisioning server to the storage server 22 and is stored therein, step 108. The network interface system 10 then checks or verifies that the final configuration file has been stored in the storage server 22, step 110. If the system determines that the final configuration file has not been received by and stored in the storage server 22, then the system 10 waits for the file to be stored therein, step 112. If the file has been stored therein, then the system 10 waits for the installer to power on the network interface device 30, step 114. The system 10 then waits for the installer to power on the network interface device 30 when connected to a selected port of the controller 40, such as for example Port 7 that corresponds to the network connection for the device 30, step 116. The network interface device 30 then receives additional device and/or user related information, such as the IP address assignment from the relay server 24, as part of a remote field identification (ID) that can include the MAC address. The IP address can be static or dynamic. The IP address allows the network interface device 30 to communicate on the network without requiring manual configuration. The relay server 24 can also provide domain name server (DNS) addresses to the network interface device 30 for helping resolve domain names into IP addresses. The network interface device can be powered on and perform a boot sequence to process a locally stored copy of the initial configuration device or the network interface device 30 can optionally download the initial configuration file (e.g., a file that holds settings for how the NID operates) from the server 12 and the initial configuration file is stored in the memory element 44, step 118. The network interface device 30 then reboots automatically and uses the information in the initial configuration file, such as the server address, to download the final configuration file stored in the storage server 22, step 120. The network interface device 30 can be optionally configured to always try or to intermittently try to download a new configuration file (e.g., a new final configuration file) every time the NID is rebooted, provided that the configuration file stored in the memory element 44 contains a valid address of the storage server 22, such as a valid secure file transfer protocol (SFTP) server address. If the network interface device 30 downloads a new final configuration file, then the controller 40 checks to see if the configuration file matches the configuration file stored in the memory element 40. If the files do not match, then the controller 40 stores the newly downloaded configuration file. If it matches, then the controller 40 does not store the configuration file. Further, if the configuration files need to be changed, then the server 12 can push a new initial configuration file to the provisioning server 20, which can create a new final configuration file. The new final configuration file can be conveyed to and stored in the storage server 22, and then the network interface device 30 is remotely or locally rebooted so as to download the new final configuration file. The controller 40 then compares the new final configuration file with the configuration file stored in the memory element 44, and if the files do not match, the new final configuration file is stored therein and the device is rebooted so as to load the new final configuration file, step 122. The installer can also reboot the customer router 32, step 124, and the customer then has Internet access, step 126. For final configuration files that use the relay server 24, the option 82 remote ID field needs to match the MAC address of the network interface device 30, port number, and network (e.g., LAN or VLAN) in the ISP provisioning server 20 in order for the customer to receive an IP address. For example, the remote ID field can have an address, such as 0001de123456010001, where the “0001de123456” address portion corresponds to the MAC address of the network interface device 30, the address portion “01” corresponds to the port number of the device, and the address portion “0001” corresponds to the network (e.g., LAN, VLAN, or WAN) used by the port 0001. The final configuration file can also include information directed to the status of the relay mode (e.g., enabled or not), relay server IP address, relay information mode (e.g., enabled or not), relay information policy data, and custom remote ID information (e.g., enabled or not). The relay server 24 can employ any suitable protocol (e.g., DHCP) to provide additional information about the location of a customer requesting an IP address can add information (via option 82) directed to the location of the customer.

Further, upon initial boot up, the bootloader of the controller 40 can load the default or initial configuration file stored in the memory element 44, which specifies DHCP for IP and DNS, and also specifies the hostname, username, password and path of the storage server 22. After the final configuration file is loaded, the network interface device 30 attempts to retrieve an IP address using standard DCHP protocol from the local network which has restricted Internet access. After the IP address is obtained, such as from the provisioning server 20, the network interface device 30 attempts to load a uniquely named final configuration file from the storage server 22 using the SFTP credentials in the configuration file. A separate initial configuration file can be created for each NID and can be customized. If the final configuration file is found, the controller 40 can compare the final configuration file to the configuration file stored in the memory element 44. If the final configuration file is different, then the new final configuration file is saved in the memory 44 and the device is rebooted using the new final configuration file.

In this manner, multiple storage servers 22 can be specified that have different final configuration files, which can be loaded with various provisioning settings for the network interface device 30. Typically, the initial configuration file is downloaded from the server 12 and managed by the NID manufacturer. The server 12 can store the initial configuration files only for NIDs that are authorized for use and only for specific internet service providers. The initial configuration files stored in the server 12 can include credentials for an ISP maintained by the storage server 22 that hold the final configuration file which is added only after the customer account has been created. The final configuration file can include device settings related to port speed, Quality of Service (QOS), VLANs, Port Isolation, and other switch port settings. In addition, the final configuration file can specify a selected relay server address (e.g., DHCP relay server address) with credentials. When an end user device, such as the router 32, is attached to an authorized port, the device can send a DHCP request to the NID. The NID can forward the received DHCP request with the Option 82 field appended. Instead of using the standard remote ID field which consists of the VLAN and Port, the MAC address can be added to the remote ID to allow the ISP to specifically link a NID and Port with an individual customer. This prevents unauthorized NIDs from being used. The end users can be prevented from making configuration changes to the network interface device 30 based on user access restrictions set by the service provider, as well as encryption for all passwords used in the final configuration file. The GPS information can be used to geo-fence the use of the network interface device 30 to a specific area as well as provide visual mapping information via the GUI or a Network Map. The final configuration file can include coordinates that form a perimeter and if the NID is outside of the perimeter then the functionality of the NID can be restricted by reducing bandwidth or by being disabled.

The controller 40 can include suitable software for controlling and monitoring the device operation and can include auto-configuration provisions. For example, upon initial boot up, the controller bootloader can load the default configuration file stored in memory 44, which specifies the DHCP for IP and DNS, and also specifies the SFTP server hostname, username, password and path. After the configuration is loaded, the NID can retrieve an IP address using standard DCHP protocol from the local network which has restricted Internet access. After the IP address is obtained, the system attempts to load a uniquely named configuration file using the SFTP credentials in the configuration file. A separate final configuration file can be created for each NID and can be customized. If the final configuration file is located, the controller 40 compares the final configuration file to the file stored in memory. If the final configuration file is different, then the final configuration file is saved in memory and the network interface device 30 is rebooted. In this manner, multiple storage servers 22 can be specified that have different final configuration files which can be loaded with various provisioning settings for the network interface device 30.

The initial configuration file can be downloaded from the server 12 and is managed by the NID manufacturer. The server 12 contains initial configuration files only for NIDs that are authorized for use and only for specific service providers. The initial configuration files on the server 12 have credentials for an ISP maintained SFTP server 22 that holds the final configuration file which is added only after the customer account has been created. The final configuration files can contain NID settings for port speed, Quality of Service (QOS), VLANS, Port Isolation, and all other typical switch port settings. In addition, the final configuration file can specify a DHCP relay server 24 address with credentials. When an end user device such as a router 32 is attached to an authorized port, it sends a DHCP request to the NID. The NID software can forward the received DHCP request with the Option 82 field appended. Instead of using the standard remote ID field which consists of the VLAN and Port, the MAC address is added to the remote ID to allow the ISP to specifically link a NID and Port with an individual customer. This prevents unauthorized NIDs from being used,

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

I claim:

1. A method of provisioning a network interface device, comprising
providing a network interface device having a controller for controlling the network device and a plurality of ports, wherein one or more of the plurality of ports are associated with a user, wherein the controller includes memory for storing an initial configuration file associated with the network device,
storing the initial configuration file and generating from the initial configuration file a final configuration file based on network interface device related information, including Quality of Service information and device identification information,
processing the initial configuration by the network interface device when a boot sequence is initiated,
receiving address information associated with the network interface device,
locating and downloading by the network interface device the final configuration file, and
automatically rebooting the network interface device to process the final configuration file.

2. The method of claim 1, wherein the step of receiving address information comprises receiving a media access control (MAC) address.

3. A network interface system, comprising
a network interface device having a controller for controlling the network device and a plurality of ports, wherein one or more of the plurality of ports are associated with a user, wherein the controller includes memory for storing an initial configuration file associated with the network device,
a first server for storing the initial configuration file and for generating from the initial configuration file a final configuration file based on network interface device related information, including Quality of Service information and device identification information, wherein the first server can be configured to assign an internet protocol (IP) address to the network device, and
a relay server for identifying selected device information associated with the network interface device,
wherein the controller includes a processor that can execute suitable instructions to, upon boot up, download and execute the final configuration file.

4. The system of claim 3, wherein the selected device information comprises location information associated indicative of the location of the network interface device.

5. The system of claim 4, wherein the device identification information includes a media control access (MAC) address.
